(19) United States
(12) Patent Application Publication
(10) Pub. No.: US 2023/0253696 A1
(43) Pub. Date: Aug. 10, 2023

(54) INSULATING GLAZING UNIT AND GLAZING

(71) Applicant: SAINT-GOBAIN GLASS FRANCE, COURBEVOIE (FR)

(72) Inventors: Thomas HOLTSTIEGE, SCHWELM (DE); Alicia DRÖGE, HERZOGENRATH (DE); Klaus SOLBACH, MÜLLHEIM-RUHR (DE); Bernd GECK, HANNOVER (DE)

(21) Appl. No.: 18/008,610

(22) PCT Filed: Sep. 6, 2021
(86) PCT No.: PCT/EP2021/074453

§ 371 Date: Dec. 6, 2022

(30) Foreign Application Priority Data
Sep. 23, 2020 (EP) 20197749.3

(51) Int. Cl. H01Q 1/12; E06B 3/663; E06B 3/24; E06B 7/28; H01Q 13/10; H01Q 1/22

(52) U.S. Cl. CPC H01Q 1/1271; E06B 3/66352; E06B 3/24; E06B 7/28; H01Q 13/106; H01Q 1/2225; E06B 3/6621

(57) ABSTRACT

An insulating glazing unit includes at least one spacer, which is shaped around the periphery to produce a spacer frame and delimits an inner region, a first glass pane, which is arranged on a first pane contact surface of the spacer frame, and a second glass pane, which is arranged on a second pane contact surface of the spacer frame, and the glass panes project beyond the spacer frame and an outer region is formed, which is filled at least in some sections, with a sealing element, wherein at least one RFID transponder is arranged in the outer region or in the outer edge region of the glass panes, and the RFID transponder contains a slot antenna.

The invention relates to an insulating glazing unit, which has at least two glass panes and, therebetween, a spacer and sealing profile around the periphery near their edges, wherein at least one RFID transponder is attached to the insulating glazing unit as an identification element. The invention further relates to a glazing with a metallic frame and an insulating glazing unit inserted into the frame, wherein the frame engages the edges of the insulating glazing unit and, at the same time, covers the RFID transponder(s). The glazing is, in particular, intended to form a facade glazing, a window, a door, or an interior partition with a corresponding structure.

Modern windows, doors, and facade glazings, at least for use in northern and temperate latitudes, are usually produced using prefabricated insulating glazing units (IGUs) that have the aforementioned structure, but, optionally, can include even more than two glass panes in the combination. Such insulating glazing units are mass-produced, shipped, and also independently marketed products that should be uniquely identifiable en route to an end product and possibly even during maintenance and servicing.

It is already known to provide insulating glazing units with identifying markings, and certain manufacturer and user requirements have arisen in the related practice:
The identifying marking should not be visible either from the inside or from the outside of the finished window, door, or facade.
The marking should be “readable” from a distance of at least 30 cm.
The marking should be as forgery-proof as possible, i.e., should not be readily possible to overwrite or to copy.

The effectiveness of conventional identifying markings, such as barcodes or QR codes, is based on their visibility, which means at least one restriction under the first aspect above. Meeting the second requirement is also difficult. Protection against copying cannot be guaranteed since barcodes and QR codes can be photographed.

It has also been proposed to provide insulating glazing units with “electronic” identifiers, in particular identifiers readable via radio, so-called “RFID transponders”. RFID transponder are known, for example, from WO 2016/198914 A1. Such insulating glazing units are, for example, disclosed in WO 00/36261 A1, WO 2020/156870 A1, WO 2020/156871 A1, or WO 2007/137719 A1. Furthermore, RFID transponders for marking solid and composite solid material panels are known from EP 2 230 626 A1.

Such an RFID transponder can be protected with a password such that it cannot be overwritten or its radio capability destroyed without considerable effort.

Certain types of window and door frames, but especially facade constructions in which insulating glazing units are installed are made completely or at least partially of a metal (aluminum, steel . . . ), which interrupts or at least greatly attenuates the passage of radio waves from or to the RFID transponder on the insulating glazing unit. For this reason, meeting the second requirement above has, in particular, proved difficult. Known insulating glazing units provided with RFID transponders are, consequently, not readily usable with metal frame constructions. This reduces the potential range of application of glazing units identified in this manner and thus the acceptance of these marking solutions by manufacturers and users.

The object of the invention is, consequently, to provide an improved insulating glazing unit for glazings with frame constructions, which frame constructions are made, at least to a considerable extent, of a metal and which insulating glazing unit also ensures meeting the aforementioned requirements in such installation situations.

This object is accomplished in accordance with a first aspect of the invention by an insulating glazing unit with the features of claim 1. In accordance with the other aspect of the invention, it is accomplished by a glazing with an insulating glazing unit according to the invention. Expedient further developments of the concept of the invention are the subject matter of the respective dependent claims.

The invention comprises an insulating glazing unit, comprising:
at least one spacer, which is shaped around the periphery to produce a spacer frame and delimits an inner region,
a first glass pane, which is arranged on a first pane contact surface of the spacer frame, and a second glass pane, which is arranged on a second pane contact surface of the spacer frame, and
the glass panes project beyond the spacer frame and form an outer region, which is filled, at least in some sections, preferably entirely, with a sealing element,
wherein
at least one RFID transponder is arranged in the outer region or in the outer edge region of the glass panes, and
the RFID transponder contains a slot antenna.

According to the invention, at least one RFID transponder is arranged in the outer region (between the glass panes and around the spacer frame) or in the outer edge region of the glass panes.

In the context of the present invention, the outer edge region of the glass panes is formed by the end faces of the glass panes and by a region of the outer surfaces of the glass panes near the end faces.

In the context of the present invention, the term “outer surface of the glass pane” refers to the respective surface of the glass pane facing away from the spacer frame, and the term “inner surface of the glass pane” refers to the surface of the glass pane facing the spacer frame.

Another aspect of the invention comprises a glazing, in particular a facade glazing, a window, a door, or an interior partition, comprising:
a frame and
an insulating glazing unit according to the invention arranged in the frame.

In a glazing according to the invention, the RFID transponder can be arranged directly on the insulating glazing unit or can be indirectly connected to the insulating glazing unit via the frame.

In an advantageous embodiment of a glazing according to the invention, the frame comprises or consists of a metallic first frame element, a metallic second frame element, and a polymeric third frame element connecting the frame elements and surrounding them at least in some sections and preferably entirely.

The frame engages, preferably in the shape of a U, the end face of the insulating glazing unit and, at the same time, covers the RFID transponder(s) in the through-vision direction through the glass panes. Usually, the legs of the first and second frame elements are designed such that they at least entirely cover the outer region and the spacer frame in the through-vision direction through the insulating glazing unit.

All the exemplary embodiments mentioned thus far and in the following apply, to the extent technically possible and reasonable, both to insulating glazing units according to the invention and to glazings according to the invention.

The invention is based on the following finding: According to current prior art, transponders with simple dipole structures are used as antennas for UHF RFID applications. These generally exhibit good reception and transmission properties under far-field conditions.

However, in an insulating glazing unit according to the invention and in particular in an application in which the insulating glazing unit is mounted in a metal frame, far-field conditions are not present. The prior art RFID transponder with a dipole antenna interacts unpredictably with the metal frame. Performance (in terms of reading distance) is reduced to values of a few centimeters, depending on the particular geometry of the facade frame and the insulating glazing unit.

Without wishing to be bound by any specific theory, one of the main reasons for the poor performance is the main direction of the nearby metallic parts of the frame or of the spacer relative to the dipole antenna of the RFID transponder. The component of the electrical field (hereinafter “E field” for short) of the dipole antenna of a prior art RFID transponder is aligned parallel to the direction of the (longitudinal direction) of the dipole antenna in the near-field region. Due to the usual length of the dipole antenna of several centimeters, it has to be arranged parallel to the course of the metallic frame or of the spacer when installed in the region covered by the frame of the glazing. In other words, the nearby parts of the frame and the electrical field of the dipole antenna are parallel such that the E field can be absorbed by the frame. The signal is then “trapped” in the frame and cannot be emitted or can only be emitted in an attenuated manner to the outside of the glazing where the RFID reader would be situated.

Installation of the dipole antenna perpendicular to its conventional direction must be ruled out. In this direction, there is only room for a dipole transponder with insufficient basic performance.

As investigations by the inventors surprisingly showed, this problem can be overcome by an RFID transponder according to the invention with a slot antenna.

Slot antennas also have an elongated design. However, the E-field typically runs perpendicular to the direction of extension of the slot antenna. In other words, in the case of the slot antenna, the E-field runs orthogonal to the E-field of a dipole antenna. The same applies to the H-fields.

If an RFID transponder according to the invention with a slot antenna is arranged in a glazing according to the invention in the usual and, for geometric reasons, only possible orientation (i.e., with the direction of extension parallel to the adjacent frame or spacer), the radiated E-field in the near field region is orthogonal to the direction of extension of the frame or spacer. In such a configuration, the E-field is only slightly absorbed or attenuated. Consequently, the E-field radiated by the slot antenna can much more easily emerge from the cavity (formed by the facade frame and spacer) and the RFID transponder according to the invention can be read from a greater distance.

The invention is a result of extensive experimental investigations undertaken on insulating glazing units and glazings with the aforementioned basic structure.

Advantageous spacers consist of a desiccant-filled hollow profile that is made of metal or is coated at least in some sections with a metal foil or a metallized film, and in which a (likewise circumferential) sealing element is applied on the surface of the spacer outside the panes (hereinafter referred to as “outer surface of the spacer”).

With regard to the application situation, the inventors carried out, in particular, investigations on insulating glazing units enclosed in metallic frames, wherein the frame consists of two metal and thus electrically conductive frame elements that are connected via a polymeric and electrically insulating frame element. Such frames made of two metallic frame elements that are connected by a polymeric frame element are particularly advantageous since the polymeric frame element significantly reduces heat transfer from the first frame element to the second frame element and, thus, for example, from an exterior-space side to an interior-space side.

Elastomer profiles that seal the glazing and fix the glass panes are arranged between the outer sides of the glass panes and the inner sides of the adjacent metallic frame elements.

In an advantageous embodiment of an insulating glazing unit according to the invention, the RFID transponder includes RFID electronics that are galvanically connected or electromagnetically coupled to a slot antenna. Here, “electromagnetically coupled” means that the slot antenna and the RFID transponder are coupled by an electromagnetic field, i.e., are connected both capacitively and inductively and preferably not galvanically.

Such designs can be arranged particularly well in the elongated and strip-shaped outer region along the spacer and between the glass panes, on the end faces of the glass panes, or on the outer surfaces of the glass panes within the frame.

“Slot antennas” are known per se to the person skilled in the art, for example, from DE894573.

The slot antenna according to the invention contains at least one base body made of an electrically conductive material. The base body is preferably in the form of a plate or foil, particularly preferably with a rectangular base surface (length×width).

The base body has at least one, preferably exactly one, slot-shaped cutout, called “slot” in the following for short. The slot-shaped cutout is essentially rectangular. The slot forms an open passage along the thickness direction (i.e., the smallest dimension of the base body) from the upper side of the base body to its lower side. The slot is completely surrounded by the base body in the surface (i.e., in the other dimensions).

In an alternative advantageous embodiment of the insulating glazing unit according to the invention, the base body contains or consists of self-supporting metal foil, preferably of aluminum, an aluminum alloy, copper, silver, or stainless steel. Preferred metal films have a thickness of 0.02 mm to 0.5 mm and in particular of 0.09 mm to 0.3 mm. Such base bodies for slot antennas can be readily integrated into the insulating glazing unit and can also be produced simply and economically. It goes without saying that the metal foil can also be stabilized by a polymer film or can be electrically insulated on one or both sides. The slot is preferably a cutout only in the metal foil or in the metal foil and the polymer film.

In an alternative advantageous embodiment of the insulating glazing unit according to the invention, the base body of the slot antenna contains or consists of a metallized polymer film with a preferred metallization of aluminum, an aluminum alloy, copper, silver, or stainless steel. Preferred metal layers have a thickness of 10 μm to 200 μm. The slot is advantageously a cutout only in the metallization.

Such base bodies can also be readily integrated into the insulating glazing unit and can, moreover, be produced simply and economically.

The preferred lengths and widths of the slot antenna, i.e., the length LG and the width BG of the base body and the length LS and the width BS of the slot as well as the position of the slot within the base body depends on the operating frequency of the RFID transponder and the respective conditions of the installation situation.

Advantageously, the length LG of the base body, i.e., the length parallel to the direction of extension of the slot antenna is from 25 mm to 200 mm, preferably from 40 mm to 170 mm, and in particular from 80 mm to 150 mm.

Advantageously, the width BG of the base body, i.e. the length transverse to the direction of extension of the slot antenna is from 10 mm to 80 mm, preferably from 12 mm to 40 mm, and in particular from 15 mm to 30 mm.

Advantageously, the length LS of the slot, i.e., the length parallel to the direction of extension of the slot antenna is from 20 mm to 180 mm, preferably from 35 mm to 160 mm, and in particular from 70 mm to 140 mm.

Advantageously, the width BS of the slot, i.e., the length transverse to the direction of extension of the slot antenna is from 0.2 mm to 20 mm, preferably from 1 mm to 10 mm, and in particular from 2 mm to 5 mm.

The person skilled in the art will carry out the further specific dimensioning in consideration of the dimensions of the insulating glazing unit on the one hand and the enclosing frame on the other, in particular taking into account the width of the frame.

The RFID electronics are preferably arranged centrally relative to the direction of extension of the slot or in one of the end regions of the slot or somewhere therebetween and galvanically connected and/or electromagnetically coupled to the base body. The selection of the position of the RFID electronics can be used to optimize the impedance matching between the RFID electronics and the antenna.

The radio wavelengths used in such RFID transponder systems are usually, depending on type, in the range of UHF at 865-869 MHz (including European frequencies) or 902-928 MHz (US and other frequency bands) or of SHF at 2.45 GHz and 5.8 GHz. The frequencies released for UHF-RFID transponders differ regionally for Asia, Europe, and America and are coordinated by the ITU.

For RFID transponders in the UHF range, in particular for RFID transponders at 865-869 MHz (including European frequencies) or 902-928 MHz (US and other frequency bands), particularly good results were obtained

Radio signals with these frequencies penetrate both wood and conventional plastics, but not metals. In particular, when the entire slot antenna is arranged directly on a metallic spacer or on a metallic foil or on a metallized film on the spacer, this can lead to a short-circuit of the slot antenna and thus to undesirable impairment of the RFID transponder.

In a preferred embodiment, the slot antenna according to the invention can be coupled in some sections to a metal body, such as a metallic spacer or a metallic foil or a metallized film on the spacer. For this purpose, a strip of the base body is preferably brought between the slot and the border of the base body in the immediate vicinity of or in contact with the metal body, with the strip of the base body opposite the slot and the slot itself arranged as far away from it as possible. A strip of the base body can, for example, be arranged on the metallic or metallized spacer, and the slot and the opposite strip of the base body can be arranged angled at an angle of approx. 90° on the inner surface of one of the glass panes.

Alternatively, in a preferred embodiment of the RFID transponder, the slot antenna can be arranged on a dielectric carrier element, particularly preferably a polymeric carrier element. The thickness of the carrier element is adapted to the material and, in particular, to the dielectric constant of the carrier element and to the geometry of the slot antenna.

It goes without saying that the slot antennas together with RFID electronics per se can be arranged on a dielectric carrier layer and, for example, a polymeric carrier layer, significantly simplifying assembly and prefabrication.

The findings of the inventors apply in principle to both passive and active RFID transponders.

In light of the metal frame that engages the insulating glazing unit, and that, based on elementary laws of physics and according to the knowledge of the person skilled in the art based thereon, can sensitively interfere with the RF radiation of RFID transponders mounted near the edge or their dipole antennas, the proposed solution is surprising. It yields the unforeseen advantage that an RFID transponder according to the invention with a slot antenna can still be read out problem-free and reliably at a relatively great distance from the glazing in which the insulating 30 glazing unit according to the invention is installed.

It goes without saying that, by simple experiments, the person skilled in the art can find designs and positions with advantageous transmission and reception properties. The exemplary embodiments and aspects mentioned below are consequently primarily recommendations for the person skilled in the art, without restricting the implementation possibilities of the invention.

Thus, it goes without saying that an insulating glazing unit can have a plurality of RFID transponders, in particular in the edge regions or outer regions of the different sides (top, bottom, right, left) of the insulating glazing. This is usually necessary with prior art insulating glazings with only short ranges of the RFID transponders in order to quickly find an RFID signal and quickly identify the insulating glazing unit. As a result of the increase according to the invention in the range of the RFID transponders, exactly one or few RFID transponders per insulating glazing usually suffice.

In an advantageous embodiment of an insulating glazing unit according to the invention, the slot antenna is arranged, at least in some sections, on the end face of the insulating glazing unit. It can preferably be arranged on a section of an end face of one of the glass panes and/or on the outer side of the outer region, for example, on the outer surface of the sealing element. Alternatively, the slot antenna can also be arranged in some sections within the outer region and, in particular, extend into the sealing element. Alternatively, the slot antenna and/or the complete RFID transponder can be entirely embedded within the sealing element.

Alternatively, the slot antenna can also be arranged on at least one of the two end faces of the glass panes and on the interposed outer side of the outer region or within the outer region.

In another advantageous embodiment of an insulating glazing unit according to the invention, the slot antenna or the entire RFID transponder is arranged on one of the outer surfaces of one of the glass panes. The distance of the slot antenna from the (metallic) frame element depends in particular on the thickness of the elastomer, which is, for example, 6 mm to 7 mm.

In another advantageous embodiment of an insulating glazing unit according to the invention, the RFID transponder is arranged, preferably directly, on the outer face of the spacer and is, in particular, glued thereon.

In an alternative advantageous embodiment of an insulating glazing unit according to the invention, the RFID transponder is arranged, preferably directly, on one of the glass panes and is, in particular, glued thereon. It goes without saying that the RFID transponder can also be arranged within the material of the sealing element, for example, by insertion into the still liquid sealing element and subsequent curing or solidification.

In an advantageous embodiment of an insulating glazing unit according to the invention, the RFID transponder is arranged in the outer region, formed by the projection of the glass panes beyond the spacer frame. The RFID transponder is particularly preferably arranged directly on the outer surface of the spacer and/or on the inner surface of one of the glass panes. Alternatively, the RFID transponder can be arranged centrally in the outer region, i.e., without direct contact with the outer surface of the spacer and without direct contact with the inner surfaces of the glass panes.

The RFID transponder according to the invention is preferably arranged partially or entirely within the sealing element.

In another advantageous embodiment of an insulating glazing unit according to the invention, the RFID transponder is arranged on an outer surface of one of the glass panes, preferably at a distance of at most 10 mm, particularly preferably at most 5 mm, and in particular of at most 3 mm from the adjacent end face of the respective glass pane.

It goes without saying that a plurality of RFID transponders can even be arranged at positions different from those mentioned above.

Advantages and functionalities of the invention are also evident from the following description of exemplary embodiments and aspects of the invention with reference to the figures. The drawings are purely schematic representations and not to scale. They in no way restrict the invention. They depict:

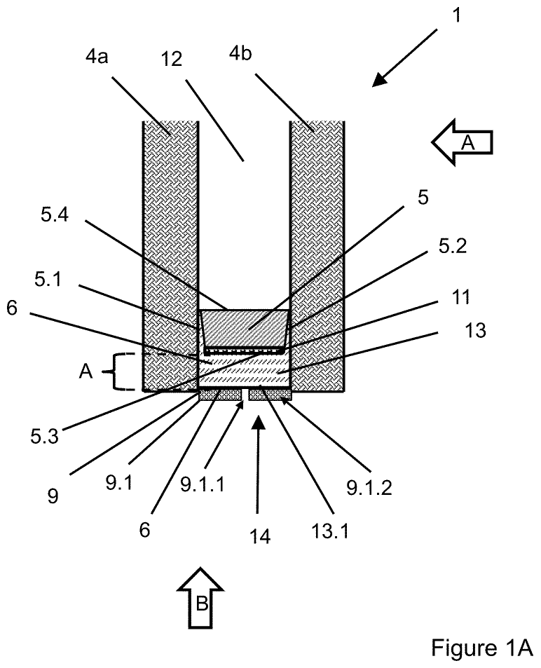

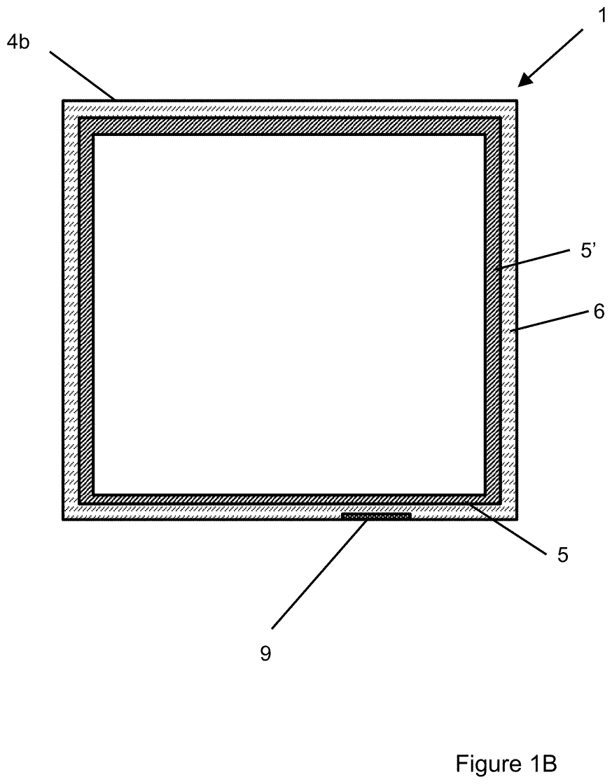

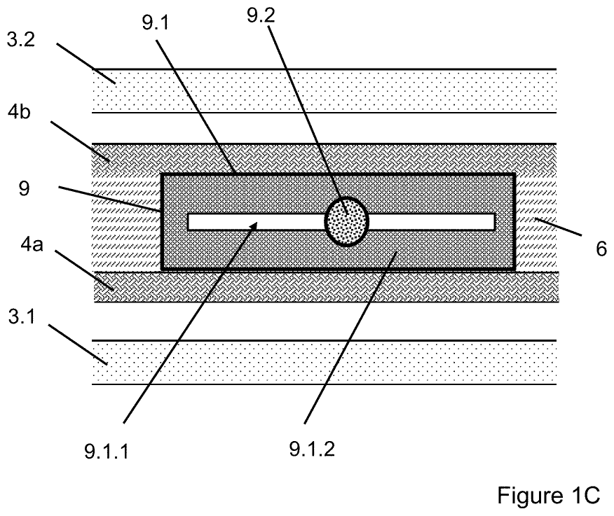

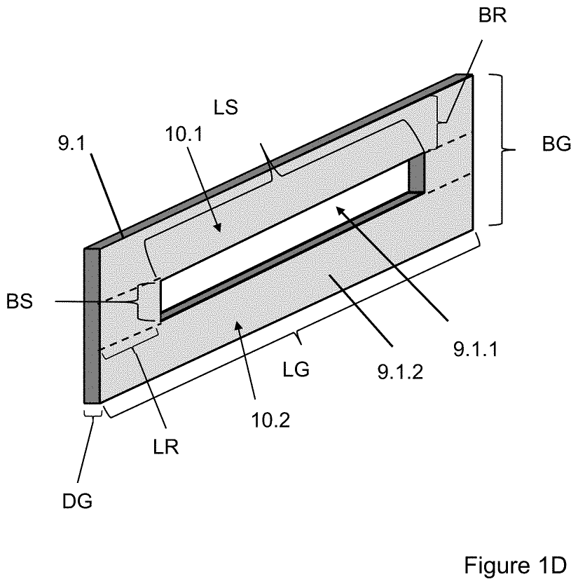

FIG. 1A a detailed view (cross-sectional representation) of an edge region of an insulating glazing unit in accordance with an embodiment of the invention,

FIG. 1B a plan view of an insulating glazing unit in accordance with the embodiment of the invention of FIG. 1A,

FIG. 1C a plan view of a detail of the edge region of an insulating glazing unit in accordance with the embodiment of the invention of FIG. 1A,

FIG. 1D a detailed view (perspective representation) of a slot antenna according to the invention,

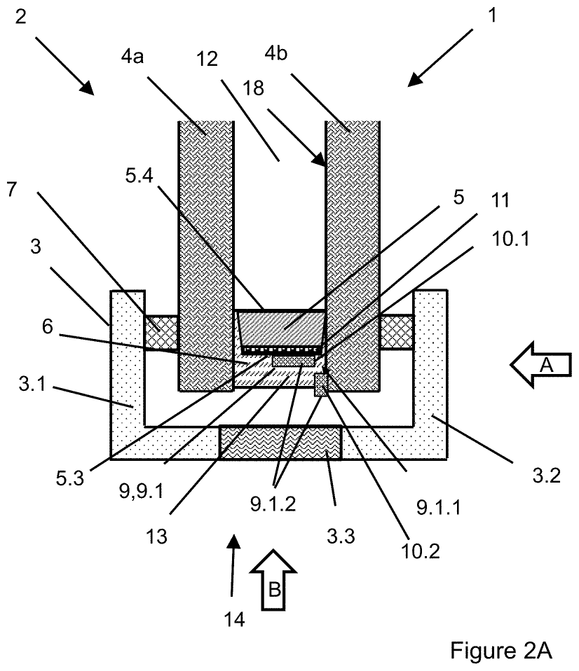

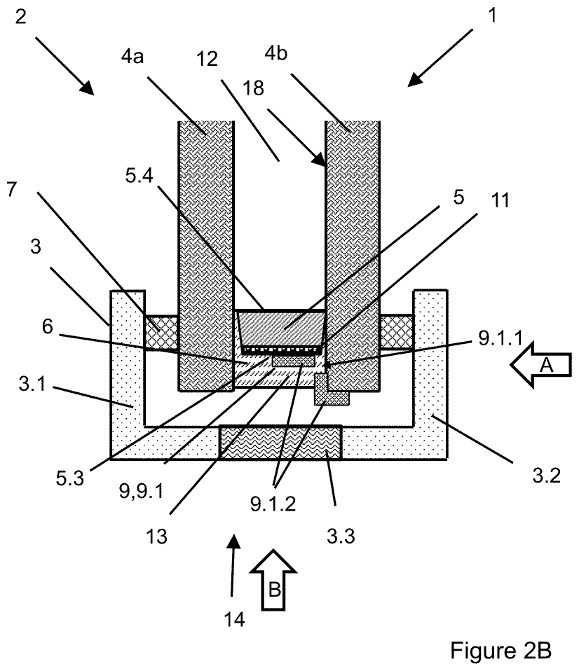

FIG. 2A a detailed view (cross-sectional representation) of an edge region of a glazing with an insulating glazing unit in accordance with another embodiment of the invention,

FIG. 2B a detailed view (cross-sectional representation) of an edge region of a glazing with an insulating glazing unit in accordance with another embodiment of the invention,

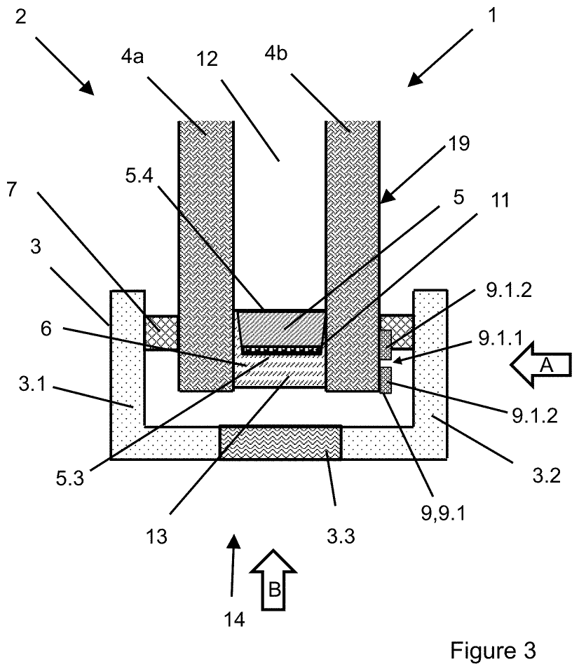

FIG. 3 a detailed view (cross-sectional representation) of an edge region of a glazing with an insulating glazing unit in accordance with another embodiment of the invention,

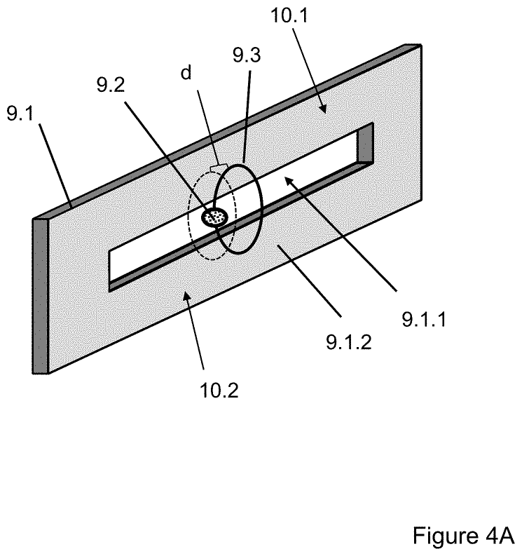

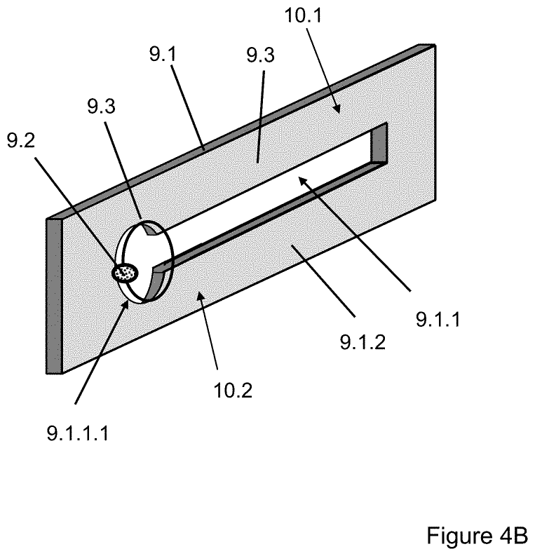

FIG. 4A a detailed view (perspective representation) of an alternative slot antenna according to the invention, and

FIG. 4B a detailed view (perspective representation) of another alternative slot antenna according to the invention.

In the figures as well as the following description, the insulating glazing units as well as the glazings and the individual components are in each case identified with the same or similar reference numbers, regardless of the fact that the specific embodiments differ.

FIG. 1A depicts an edge region of an insulating glazing unit 1 in cross-section. The insulating glazing unit 1 comprises, in this embodiment, two glass panes 4a and 4b. These are held apart at a predetermined distance by a spacer 5 placed between the glass panes 4a, 4b near the end face 14 of the insulating glazing unit 1. The main body of the spacer 5 is made, for example, of glass-fiber-reinforced styrene acrylonitrile (SAN).

FIG. 1B depicts a schematic plan view of the insulating glazing unit 1 in a viewing direction indicated by the arrow A in FIG. 1A. FIG. 1B therefore depicts the second glass pane 4b lying on top.

Multiple spacers 5 (here, for example, four) are routed along the side edges of the glass panes 4a, 4b and form a spacer frame 5′. The pane contact surfaces 5.1, 5.2 of the spacers 5, i.e., the contact surfaces of the spacers 5 with the glass panes 4a, 4b, are bonded in each case to the glass panes 4a or 4b and thus mechanically fixed and sealed. The adhesive bond consists, for example, of polyisobutylene or butyl rubber. The inner surface 5.4 of the spacer frame 5′ delimits, together with the glass panes 4a, 4b, an inner region 12.

The spacer 5 is usually hollow (not shown) and filled with a desiccant (not shown), which binds, via small interior-side openings (likewise not shown), any moisture that has penetrated into the inner region 12. The desiccant contains, for example, molecular sieves such as natural and/or synthetic zeolites. The inner region 12 between the glass panes 4a and 4b is filled, for example, with a noble gas, such as argon.

The glass panes 4a, 4b usually project beyond the spacer frame 5′ on all sides such that the outer surface 5.3 of the spacer 5 and the outer sections of the glass panes 4a, 4b form an outer region 13. A sealing element (sealing profile) 6 is introduced into this outer region 13 of the insulating glazing unit 1 between the glass panes 4a and 4b and outside the spacer 5. This is shown here in simplified form as a single piece. In practice, it usually comprises two components, one of which seals the contact surface between the spacer 5 and the glass panes 4a, 4b and protects against penetrating moisture and external influences. This can be identical to or combined with the adhesive surfaces between the spacer 5 and the glass panes 4a,4b. The second component of the sealing element 6 additionally seals and mechanically stabilizes the insulating glazing unit 1. The sealing element 6 is, for example, formed from an organic polysulfide.

An insulation film 11, which reduces the heat transfer through the polymeric spacer 5 into the inner region 12, is applied, for example, on the outer surface 5.3 of the spacer 5, i.e., on the side of the spacer 5 facing the outer region 13. The insulation film 11 can, for example, be attached to the polymeric spacer 5 with a polyurethane hot-melt adhesive. The insulation film 11 contains, for example, three polymeric layers of polyethylene terephthalate with a thickness of 12 μm and three metallic layers made of aluminum with a thickness of 50 nm. The metallic layers and the polymeric layers are attached alternatingly in each case, with the two outer plies formed by polymeric layers. In other words, the layer sequence consists of a polymeric layer, followed by a metallic layer, followed by an adhesive layer, followed by a polymeric layer, followed by a metallic layer, followed by an adhesive layer, followed by a metallic layer, followed by a polymeric layer.

As already mentioned, the main body of the spacer 5 is made, for example, of glass-fiber-reinforced styrene acrylonitrile (SAN). By means of the selection of the glass fiber content in the spacer main body, its coefficient of thermal expansion can be varied and adjusted. By adjusting the coefficient of thermal expansion of the spacer main body and of the insulation film 11, temperature-induced stresses between the different materials and flaking of the insulation film 11 can be avoided. The spacer main body has, for example, a glass fiber content of 35%. The glass fiber content in the spacer main body simultaneously improves strength and stability.

The first glass pane 4a and the second glass pane 4b are made, for example, of soda lime glass with a thickness of 3 mm and have, for example, dimensions of 1000 mm×1200 mm. It goes without saying that each insulating glazing unit 1 depicted in this and the following exemplary embodiments can also have three or more glass panes.

The insulating glazing unit 1 of FIG. 1A and 1B is, by way of example, provided with an RFID transpondern 9, on the outer surface 6.1 of the sealing element 6.

FIG. 1C depicts a schematic plan view of the edge region of the insulating glazing unit 1 of FIG. 1A in a viewing direction indicated by the arrow B of FIG. 1A.

The operating frequency of the RFID transponder is in the UHF range and is, for example, 866.6 MHz.

The example shown is an RFID transponder 9 according to the invention with a slot antenna 9.1 in which the RFID electronics 9.2 are arranged in the center of the slot 9.1.1, are attached to the adjacent regions of the base body 9.1.2 of the slot antenna 9.1, and are electrically conductively connected thereto, for example, by two galvanic connections on both sides of the slot 9.1.1 (in FIG. 1C, once at the top and once at the bottom). It goes without saying that the RFID electronics 9.2 can also be arranged at a different location and can be connected to the slot antenna 9.1 via lines, galvanic connections, or electromagnetic coupling.

FIG. 1D depicts a perspective representation of the slot antenna 9.1 according to the invention. This consists of a metallic base body 9.1.2, for example, made of a rectangular copper foil with a length LG of 140 mm, a width BG of 10 mm, and a thickness DG of 0.1 mm. The base body 9.1.2 has, for example, in the center, a slot 9.1.1 in the form of a complete cutout with a length LS of 120 mm and a width BS of 2 mm. The edge region of the base body 9.1.2 around the slot 9.1.1 is consequently approx. 10 mm in the longitudinal direction (LR) in each case and approx. 4 mm in the transverse direction (BR) in each case. It goes without saying that lengths, widths, position of the slot, material, etc. can be adapted to the respective conditions of the installation situation, the radiation characteristics, and the RFID frequency.

Two strip-shaped regions (also called strips 10.1, 10.2) are situated between the slot 9.1.1 and the edge of the base body 9.1.2 along the direction of extension. In the example of FIG. 1D, these strips 10.1,10.2 have the same width and the same length.

The base body 9.1.2 can also be made of a comparatively rigid, thin metal plate or of a very thin metal foil or metallization that can be arranged on a carrier element, preferably a dielectric carrier element, such as a polymer plate or polymer film.

The slot antenna 9.1 has a distance A from the outer surface 5.4 of the spacer 5. The spacer 5 has, as already mentioned above, a metallized and thus electrically conductive (thermal) insulation film 11. Without the distance A and the dielectric sealing element 6, the slot antenna 9.1 would be arranged directly on the electrically conductive insulation film 11 and therefore “short-circuited”.

It goes without saying that in the case of spacers 5 made of a dielectric without insulation film 11 or with purely dielectric insulation films (e.g., without metallization and, in particular, with, for example, ceramic insulation layers), the entire slot antenna 9.1 of the RFID transponder 9 can even be arranged directly on the spacer 5.

FIG. 2A depicts a detailed view (cross-sectional representation) of an edge region a glazing 2 with an alternative insulating glazing unit 1 according to the invention. The insulating glazing unit 1 of FIG. 2A essentially corresponds to the insulating glazing unit 1 or the slot antenna 9.1 according to the invention of FIG. 1A, 1B, 1C, and 1D such that, in the following, only the differences will be discussed.

In contrast to the insulating glazing unit 1 of FIG. 1A, 1B, and 1C, the RFID transponder 9 together with the slot antenna 9.1 is arranged within the outer region 13 and essentially between the spacer 5 and the sealing element 6, between the glass pane 4b and the sealing element 6, and partially within the sealing element 6.

The slot 9.1.1 of the slot antenna 9.1 is offset here, for example, 2 mm from the center of the width BG of the base body 9.1.2. The wider strip 10.1 of the base body 9.1.2 is arranged directly on the spacer 5. In the case of metallic spacers 5 or spacers 5 coated with a metallized film on the outer surface 5.3, the wider strip 10.1 of the base body 9.1.2 is coupled to the metal or the metallization between its edge and the slot 9.1.1 such that this forms part of the slot antenna 9.1 in terms of functional high-frequency technology.

The slot 9.1.1 and the narrower strip 10.2 between the slot 9.1.1 and the edge of the base body 9.1.2 are, for example, angled by approx. 90° and arranged on the inner surface 19 of the glass pane 4b in the outer region 13.

Furthermore, a, for example, U-shaped frame 3 surrounds the edges of the insulating glazing unit 1 together with the RFID transponder 9. In this example, the frame 3 consists of a first metallic frame element 3.1 that is connected to a second metallic frame element 3.2 via a polymeric and thermally and electrically insulating third frame element 3.3. In this example, the first and second frame elements 3.1, 3.2 are L-shaped. Consequently, the frame 3 engages the end face 14 of the insulating glazing unit 1 in the shape of a U. The sections of the first and second frame elements extending parallel to the large surfaces of the glass panes 4a, 4b are implemented such that they completely cover at least the outer region 13 with the sealing element 6 and the spacer frame 5′ in the through-vision direction (arrow A) through the insulating glazing unit 1.

The insulating glazing unit 1 is arranged on carriers (not shown here), in particular on plastic carriers. Furthermore, an elastomer profile 7 is arranged in each case between the metallic frame elements 3.1, 3.2 and the glass panes 4a, 4b such that the insulating glazing unit 1 is firmly held within the frame 3. The elastomer profile 7 has, for example, a thickness of 6.5 mm and fixes the distance between the respective frame elements 3.1, 3.2 and the glass panes 4a, 4b.

Due to the installation situation and the dimensions of the insulating glazing unit 1, the slot 9.1.1 of the slot antenna 9.1 runs with its direction of extension (i.e., its longitudinal direction (length LS)/longest dimension) parallel to the direction of extension of the immediately adjacent spacer 5 or of the metallic frame element 3.2. As already explained above, the E field radiated by the slot antenna 9.1 runs orthogonal to the direction of extension of the slot antenna 9.1 and thus also orthogonal to the direction of extension (longest dimension) of the spacer 5 or of the frame 3.2. Since the spacer 5 and the frame 3.2 are very narrow in the direction parallel to the E field (approx. 10 mm-40 mm), the E field is only attenuated very weakly. This results in strong radiation performance or sensitivity for signals transmitted and received in the wavelength range of the RFID operating frequency. Thus, signals could be sent to the RFID transponder 9 and read out with an RFID reader at relatively large distances.

FIG. 2B depicts a detailed view (cross-sectional representation) of an edge region of an alternative glazing 2 with an insulating glazing unit 1 in accordance with another embodiment of the invention. FIG. 2B depicts a modified design that has largely the elements and the structure of the glazing 2 with an insulating glazing unit 1 according to FIG. 2A. Thus, the same reference numbers are used as there and the structure is not described again here.

The insulating glazing units 1 of FIG. 2A and 2B differ by the shape of the slot antenna 9.1. In FIG. 2B, the base body 9.1.2 is wider and is routed all the way to the end face 14 of the glass pane 4b and, for example, glued thereto. Here, for example, the slot 9.1.1 can again be arranged centrally relative to the width BG of the base body 9.1.2.

FIG. 3 depicts a detailed view (cross-sectional representation) of an edge region of an alternative glazing 2 with an insulating glazing unit 1 in accordance with another embodiment of the invention. FIG. 3 depicts a modified design that has largely the elements and the structure of the glazing 2 with an insulating glazing unit 1 according to FIG. 2B. Thus, the same reference numbers are used as there and the structure is not described again here.

The insulating glazing units 1 of FIG. 3 and of FIG. 2B differ essentially by the position at which the slot antenna 9.1 is arranged on the insulating glazing unit 1. In FIG. 3, the RFID transponder 9 is arranged with the slot antenna 9.1 on the outer surface 18 of the glass pane 4b and, for example, fastened by gluing. Here again, the view of the RFID transponder 9 from above (in the direction of the arrow A) is obscured by the frame 3. Due to the distance between the slot antenna 9.1 and the metallic frame element 3.2 resulting from the elastomer profile 7, a high-frequency short-circuit of the slot antenna 9.1 by the frame element 3.2 is avoided.

The practice of the invention is not limited to the examples and highlighted aspects of the embodiments, but is also possible in a large variety of modifications apparent to the person skilled in the art from the appended claims.

FIG. 4A shows a perspective representation of an alternative embodiment of a slot antenna 9.1 according to the invention. This essentially corresponds in shape, dimensions, and material to the slot antenna 9.1 of FIG. 1D such that, in the following, only the differences will be discussed.

Whereas, in the case of the slot antenna 9.1 of FIG. 1D, the RFID electronics 9.2 are galvanically connected to the slot antenna 9.1, in FIG. 4A, the RFID electronics 9.2 are electromagnetically coupled to the slot antenna 9.1. For this purpose, the RFID electronics 9.2 are galvanically connected to a, for example, ring-shaped coupling antenna 9.3. The coupling antenna 9.3 is separated and galvanically isolated from the base body 9.1.2 of the slot antenna 9.1 by a distance d of, for example, 0.3 mm, via, for example, a polymeric intermediate layer (not shown) such as a plastic film.

The coupling antenna 9.3 is thus capable of exciting an electromagnetic signal in the slot antenna 9.1 or of receiving it from the slot antenna 9.1 and forwarding it to the RFID electronics 9.2.

FIG. 4B shows a perspective representation of a further development of the slot antenna 9.1 of FIG. 4A such that, in the following, only the differences relative to

FIG. 4A are discussed.

In contrast to the slot antenna 9.1 of FIG. 4A, the coupling antenna 9.3 is not arranged in the center of the slot 9.1.1 relative to the longitudinal direction, but, instead, in an end region (here, at the left end). Furthermore, the slot 9.1.1 of the slot antenna 9.1 has, in the region of the orthogonal projection of the coupling antenna 9.3 onto the base body 9.1.2, a circular cutout 9.1.1.1, which is connected to the slot-shaped cutout 9.1.1 and forms its one-sided end. By means of the circular cutout 9.1.1.1, the coupling of the coupling antenna 9.3 to the slot antenna 9.1 can be improved.

### List of Reference Characters

1 insulating glazing unit

2 glazing

3 frame

3.1,3.2 metallic, first or second frame element

3.3 polymeric, third frame element

4a, 4b glass panes

5 spacer

5′ spacer frame

5.1,5.2 pane contact surface

5.3 outer surface of the spacer 5

5.4 inner surface of the spacer 5

6 sealing element

6.1 outer surface of the sealing element 6

7 elastomer profile

9 RFID transponder

9.1 slot antenna

9.1.1 slot, slot-shaped cutout

9.1.1.1 circular section

9.1.2 base body, foil

9.2 RFID electronics

9.3 coupling antenna

10.1, 10.2 strip-shaped region, strip

11 metallized insulation film

12 inner region

13 outer region

13.1 outer side of the outer region 13

14 end face of the insulating glazing unit 1 or of the glass panes 4a, 4b

18 outer surface of the glass pane 4a or 4b

19 inner surface of the glass pane 4a or 4b

arrow A top view direction or through-vision direction

arrow B top view direction

A distance

B width of the base body 9.1.2 of the slot antenna 9.1

BS width of the slot 9.1.1

BR width of the (edge) strip 10.1,10.2

d distance

L length of the base body of the slot antenna 9.1

LD thickness of the base body 9.1.2

LS length of the slot 9.1.1

LR length of the edge

1. An insulating glazing unit, suitable for installation in a frame, which contains or consists of a metallic first frame element, a metallic second frame element, and a polymeric third frame element connecting the metallic first and second frame elements and surrounding them at least in some sections, comprising:
at least one spacer, which is shaped around the a periphery to produce a spacer frame and delimits an inner region,
a first glass pane, which is arranged on a first pane contact surface of the spacer frame, and a second glass pane, which is arranged on a second pane contact surface of the spacer frame, and
the first and second glass panes project beyond the spacer frame and an outer region is formed, which is filled at least in some sections, with a sealing element,
wherein
at least one RFID transponder is arranged in the outer region or in an outer edge region of the first and second glass panes,
the at least one RFID transponder contains a slot antenna.

2. The insulating glazing unit according to claim 1, wherein the slot antenna has a base body in the form of a plate or a foil.

3. The insulating glazing unit according to claim 1, wherein the base body has a width of 10 mm to 80 mm, and/or a length of 25 mm to 200 mm, and/or a thickness of 0.02 mm to 0.5 mm.

4. The insulating glazing unit according to claim 2, wherein the base body contains or consists of a metallized polymer film or a self-supporting metal foil.

5. The insulating glazing unit according to claim 4, wherein a metallization of the metallized polymer film has a thickness of 10 μm to 200 μm and the self-supporting metal foil has a thickness of 0.02 mm to 0.5 mm.

6. The insulating glazing unit according to claim 2, wherein the base body has at least one slot.

7. The insulating glazing unit according to claim 6, wherein the at least one slot has a width of 0.2 mm to 20 mm, and/or a length of 20 mm to 180 mm.

8. The insulating glazing unit according to claim 7, wherein RFID electronics are galvanically connected and/or electromagnetically coupled to the slot antenna.

9. The insulating glazing unit according to claim 8, wherein the RFID electronics are galvanically connected and/or electromagnetically coupled to the slot antenna centrally or in the end region or therebetween, relative to a direction of extension of the at least one slot.

10. The insulating glazing unit according to claim 1, wherein the at least one RFID transponder is arranged
in the outer region and/or
on one of inner surfaces of the first and second glass panes and/or
centrally in the outer region and/or
on an outer surface of the sealing element.

11. A glazing, comprising a frame, and an insulating glazing unit according to claim 1 arranged in the frame.

12. The glazing according to claim 11, wherein the frame engages the end faces of the insulating glazing unit and, at the same time, covers the at least one RFID transponder in a through-vision direction through the first and second glass panes.

13. The glazing according to claim 11, wherein the frame contains or consists of a metallic first frame element, a metallic second frame element, and a polymeric third frame element connecting the metallic first and second frame elements and surrounding them at least in some sections.

14. A method comprising providing a RFID transponder as an identification element in an insulating glazing unit according to claim 1.

15. The insulating glazing unit according to claim 1, wherein the polymeric third frame element entirely surrounds the metallic first and second frame elements.

16. The insulating glazing unit according to claim 1, wherein the outer region is filled entirely with the sealing element.

17. The insulating glazing unit according to claim 2, wherein the base body has a rectangular base surface.

18. The insulating glazing unit according to claim 3, wherein the width is from 12 mm to 40 mm, and/or the length is from 40 mm to 170 mm, and/or the thickness is from 0.09 mm to 0.3 mm.

19. The insulating glazing unit according to claim 4, wherein the self-supporting metal foil is made of aluminum, an aluminum alloy, copper, silver, or stainless steel.

20. The insulating glazing unit according to claim 5, wherein the self-supporting metal foil has a thickness of 0.09 mm to 0.3 mm.
